(19) United States
(12) Patent Application Publication
(10) Pub. No.: US 2010/0192067 A1
(43) Pub. Date: Jul. 29, 2010

(54) CUSTOMER SERVICE & SUPPORT SYSTEMS AND METHODS FOR USE IN AN ON DEMAND DATABASE SERVICE

(75) Inventor: Marco Casalaina, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: salesforce.com, Inc., San Francisco, CA (US)

(21) Appl. No.: 12/692,905

(22) Filed: Jan. 25, 2010

Related U.S. Application Data
(60) Provisional application No. 61/147,026, filed on Jan. 23, 2009.

(51) Int. Cl. G06F 3/01

(52) U.S. Cl. 715/742; 715/752

(57) ABSTRACT

The present invention generally relates to sharing and accessing data, and more particularly to sharing and accessing data via an on-demand database and/or application service. In various embodiments, methods for practicing techniques of the present invention, systems having elements or components configured to implement techniques of the present invention, devices, and computer-readable storage media storing executable code and/or instructions are disclosed. In one embodiment, Email To Case settings may be established. The settings may be used by an on demand database and/or application service to receive and processing incoming emails. In another embodiment, Portal Super User settings may be established. The settings may be used by an on demand database and/or application service for accessing data owned by a user and owned by other users. In a further embodiment, Case Teams may be established. The Case Teams may be used by an on demand database and/or application service for accessing data owned by a user and owned by other users and for generating notifications to team members. In yet another embodiment, Predefined Case Teams or Case Team Templates may be used to assign Case Teams or propagate changes to team memberships. In a still further embodiment, Holidays Objects may be created. The Holidays Objects may be used by an on demand database and/or application service for determining business hours and performing time-based actions.

### CROSS-REFERENCES TO RELATED APPLICATIONS

This application claims the benefit of U.S. Provisional Application Ser. No. 61/147,026 (Attorney docket No. 021735-005500US; Client Ref. 144 PROV), filed Jan. 23, 2009, the disclosure of which is incorporated herein by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention generally relates to sharing and accessing data, and more particularly to sharing and accessing data via an on-demand database and/or application service.

### BACKGROUND

An on-demand database and/or application service may be a database system and/or application system that is made available to outside users. These outside users need not necessarily be concerned with building and/or maintaining the database system and/or application system. Instead, they merely access or obtain use of the system when needed (e.g., on the demand of the users).

Some on-demand database or application services may store information from one or more users (or tenants) into tables of a common database image to form a multi-tenant database system (MTS). A relational database management system (RDMS) or the equivalent may execute storage and retrieval of information against the database object(s). An application platform may be a framework that allows applications to run and access data in the database.

Accordingly, what is desired is to solve problems relating to sharing and accessing data in an on-demand database and/or application service, some of which may be discussed herein. Additionally, what is desired is to reduce drawbacks related to sharing and accessing data in an on-demand database and/or application service, some of which may be discussed herein.

### BRIEF SUMMARY

The present invention generally relates to sharing and accessing data, and more particularly to sharing and accessing data via an on-demand database and/or application service. In various embodiments, methods for practicing techniques of the present invention, systems having elements or components configured to implement techniques of the present invention, devices, and computer-readable storage media storing executable code and/or instructions are disclosed.

In one embodiment, Email To Case settings may be established. The settings may be used by an on demand database and/or application service to receive and processing incoming emails. In another embodiment, Portal Super User settings may be established. The settings may be used by an on demand database and/or application service for accessing data owned by a user and owned by other users. In a further embodiment, Case Teams may be established. The Case Teams may be used by an on demand database and/or application service for accessing data owned by a user and owned by other users and for generating notifications to team members. In yet another embodiment, Predefined Case Teams or Case Team Templates may be used to assign Case Teams or propagate changes to team memberships. In a still further embodiment, Holidays Objects may be created. The Holidays Objects may be used by an on demand database and/or application service for determining business hours and performing time-based actions.

In one embodiment, a method performed by one or more computer systems associated with an on-demand service for handling emails includes forwarding, from at least one of the one or more computer systems associated with the on-demand service, information configured for displaying one or more user interfaces on a display device. The one or more user interfaces can be configured to accept input from users of the one or more user interfaces specifying how the one or more computer systems associated with the on-demand service handle emails. A set of Email To Case settings can be specified via the one or more user interfaces. The set of Email to Case settings can then be stored in a storage device.

In some examples of operation of the on-demand service, an email may be received at at least one of the one or more computer systems. Reception of the email may be configured by the stored Email to Case settings. Further, information associated with a Case may be generated or actions performed based on the email and the stored Email to Case settings.

In various embodiments, receiving the set of Email To Case settings specified via the one or more user interfaces can include receiving at least a routing address associated with a email services address. Receiving the set of Email To Case settings specified via the one or more user interfaces can include receiving an indication to store email headers. The on-demand system may then store metadata associated with emails. Receiving the set of Email To Case settings specified via the one or more user interfaces can also include receiving information specifying a task to create upon receiving emails. The on-demand system may then create one or more tasks for a Case. The on-demand services may further set attributes of the task based on the Email to Case settings. Additionally, receiving the set of Email To Case settings specified via the one or more user interfaces can include receiving an indication whether to notify an owner of the Case of the email. The on-demand service may then generate notifications to owners of a Case.

In further embodiments, receiving the set of Email To Case settings specified via the one or more user interfaces can include receiving an indication whether to enable HTML content associated with received emails. Receiving then set of Email To Case settings specified via the one or more user interfaces can include receiving a priority to be assigned to the Case. Receiving the set of Email To Case settings specified via the one or more user interfaces can include receiving a case origin to be assigned to the Case. Receiving the set of Email To Case settings specified via the one or more user interfaces can include receiving a case record type to be assigned to the Case. Receiving the set of Email To Case settings specified via the one or more user interfaces can include receiving one or more error handling settings.

In other embodiments, other methods, systems, devices, and computer-readable storage media may incorporate or implement all or a portion of aspects of the above discussed embodiments for Email To Case settings.

In another embodiment, a method performed by one or more computer systems associated with an on-demand service for handling user permissions can include forwarding, from at least one of the one or more computer systems associated with the on-demand service, information configured for displaying one or more user interfaces on a display device. The one or more user interfaces can be configured to accept input from users of the one or more user interfaces specifying how the one or more computer systems associated with the on-demand service handle permissions for a portal. Information establishing a portal super user specified via the one or more user interfaces can be received. The information establishing the portal super user can then be stored in a storage device.

In some examples of operation of the on-demand service, a request may be received at at least one of the one or more computer systems to access a Case. Information associated with the Case may be generated based on the stored information establishing the portal super user.

In various embodiments, generating the information associated with the Case based on the stored information establishing the portal super user can include generating information associated with a Case owned by a user with a portal super user permission. Generating the information associated with the Case based on the stored information establishing the portal super user can include generating information associated with a Case owned by another user by under a user with a portal super user permission.

In other embodiments, other methods, systems, devices, and computer-readable storage media may incorporate or implement all or a portion of aspects of the above discussed embodiments for Portal Super User settings.

In a further embodiment, a method performed by one or more computer systems associated with an on-demand service for handling user permissions can include forwarding, from at least one of the one or more computer systems associated with the on-demand service, information configured for displaying one or more user interfaces on a display device. The one or more user interfaces can be configured to accept input from users of the one or more user interfaces specifying how the one or more computer systems associated with the on-demand service handle permissions for Case Teams. A set of Case Teams settings specified via the one or more user interfaces can be received. The set of Case Teams settings can be stored in a storage device.

In some examples of operation of the on-demand service, information associated with a Case may be generated based on the stored Case Teams settings.

In some embodiments, receiving the set of Case Teams settings specified via the one or more user interfaces can include receiving information designating one or more users of the one or more computer systems as members of a Case Team. Receiving the set of Case Teams settings specified via the one or more user interfaces can include receiving information designating one or more queues as members of a Case Team. Receiving the set of Case Teams settings specified via the one or more user interfaces can include receiving information designating one or more customer portal users as members of a Case Team. Receiving the set of Case Teams settings specified via the one or more user interfaces can include receiving information designating one or more partner portal users as members of a Case Team. Receiving the set of Case Teams settings specified via the one or more user interfaces can include receiving information designating one or more contacts associated the Case as members of a Case Team.

In various embodiments, receiving the set of Case Teams settings specified via the one or more user interfaces can include receiving notification settings for a member of a Case Team. Information associated with the Case may be generated based on the stored Case Teams settings. Additionally, one or more types of notifications may be generated based on the notification settings. In one embodiment, receiving the set of Case Teams settings specified via the one or more user interfaces can include receiving sharing settings for a member of a Case Team. Receiving the set of Case Teams settings specified via the one or more user interfaces can include receiving visibility settings for a member of a Case Team.

In further embodiments, receiving the set of Case Teams settings specified via the one or more user interfaces can include receiving one or more predefined case teams. At least one of the one or more predefined case teams may be modified or updated in response to a change to a user associated with the at least one predefined case team.

In other embodiments, other methods, systems, devices, and computer-readable storage media may incorporate or implement all or a portion of aspects of the above discussed embodiments for Case Teams.

In a still further embodiment, a method performed by one or more computer systems associated with an on-demand service for handling holidays can include forwarding, from at least one of the one or more computer systems associated with the on-demand service, information configured for displaying one or more user interfaces on a display device. The one or more user interfaces can be configured to accept input from users of the one or more user interfaces specifying how the one or more computer systems associated with the on-demand service handle holidays. A set of holiday settings specified via the one or more user interfaces can be received. The set of holiday settings can be stored in a storage device.

In some examples of operation of the on-demand service, information associated with a Case may be generated based on the stored holiday settings.

In various embodiments, receiving the set of holiday settings specified via the one or more user interfaces can include receiving information defining a holiday on an individual day. Receiving the set of holiday settings specified via the one or more user interfaces can include receiving information defining a holiday on an repeating interval.

In other embodiments, other methods, systems, devices, and computer-readable storage media may incorporate or implement all or a portion of aspects of the above discussed embodiments for Holidays Objects.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE DRAWINGS

In the following drawings like reference numbers are used to refer to like elements. Although the following figures depict various examples of the invention, the invention is not limited to the examples depicted in the figures.

FIG. 1 illustrates a block diagram of an environment wherein an on-demand database service might be used.

FIG. 2 illustrates a block diagram of an embodiment of elements of FIG. 1 and various possible interconnections between these elements according to an embodiment of the present invention.

FIG. 3 is a flowchart of a method for providing Email To Case functionality in an on-demand service according to an embodiment of the present invention.

FIGS. 4, 5, 6, and 7 are screenshots of user interfaces for creating and/or modifying Email To Case settings for an on-demand service according to an embodiment of the present invention.

FIG. 8 is a flowchart of a method for providing Portal Super Users in an on-demand service according to an embodiment of the present invention.

FIG. 9 is a flowchart of a method for providing Case Teams in an on-demand service according to an embodiment of the present invention.

FIG. 10 is a flowchart of a method for generating notification based on Case Teams settings in an on-demand service according to an embodiment of the present invention.

FIG. 11 is a flowchart of a method for performing actions based on Holidays settings in an on-demand service according to an embodiment of the present invention.

### DETAILED DESCRIPTION

The present invention generally relates to sharing and accessing data, and more particularly to sharing and accessing data via an on-demand database and/or application service.

### System Overview

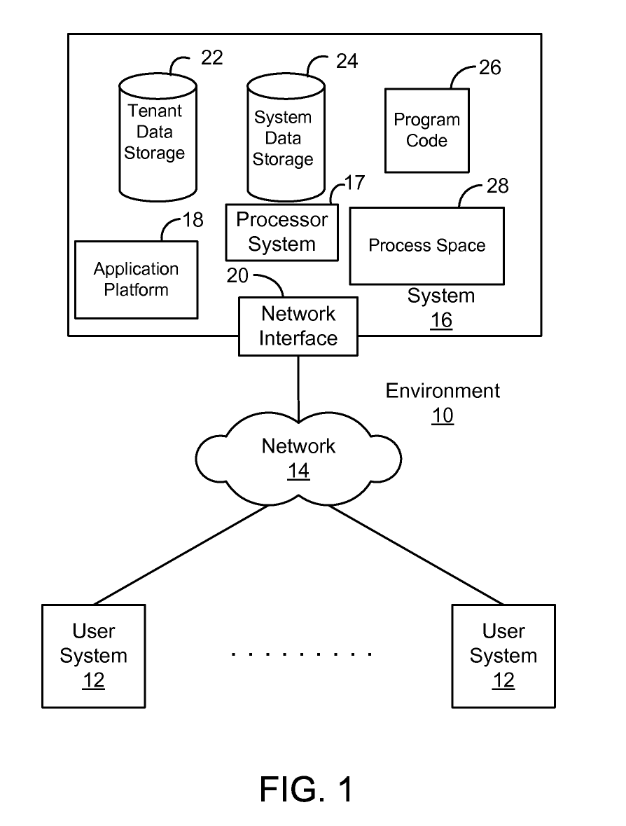

FIG. 1 illustrates a block diagram of an environment 10 wherein an on-demand database or application service might be used. Environment 10 may include user systems 12, network 14, system 16, processor system 17, application platform 18, network interface 20, tenant data storage 22, system data storage 24, program code 26, and process space 28. In other embodiments, environment 10 may not have all of the components listed and/or may have other elements instead of, or in addition to, those listed above.

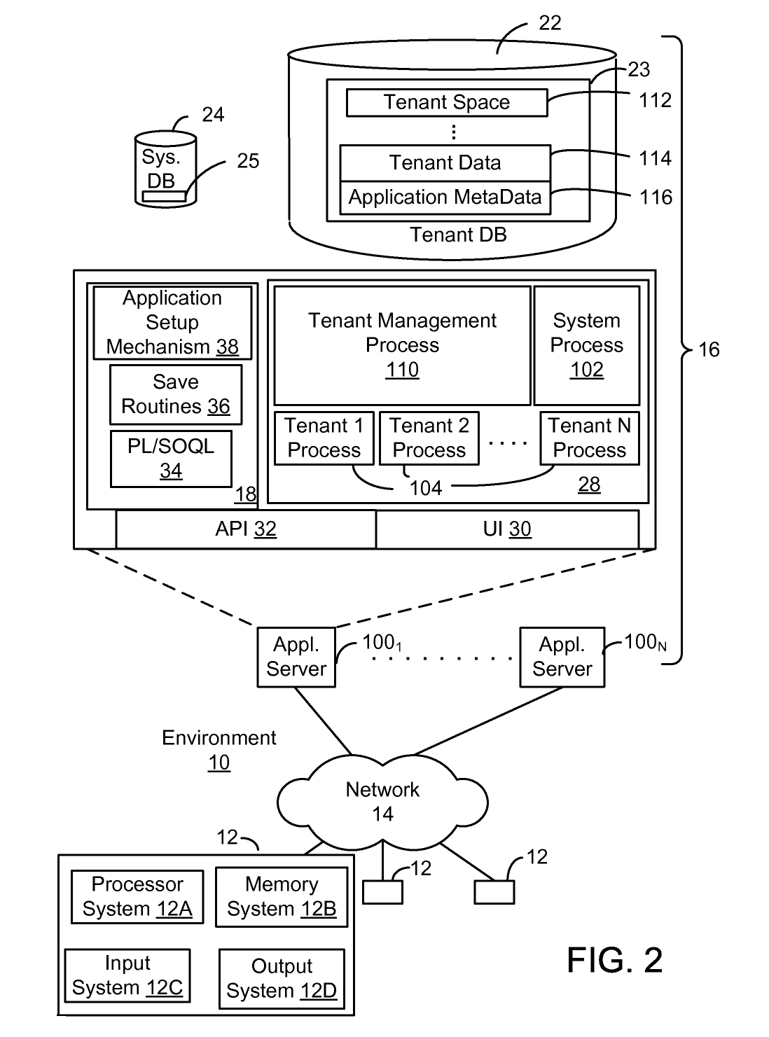

Environment 10 is an environment in which an on-demand database service exists. User system 12 may be any machine or system that is used by a user to access a database user system. For example, any of user systems 12 can be a handheld computing device, a mobile phone, a laptop computer, a work station, and/or a network of computing devices. As illustrated in FIG. 1 (and in more detail in FIG. 2) user systems 12 might interact via a network 14 with an on-demand database service, which is system 16.

An on-demand database service, such as system 16, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 16” and “system 16” will be used interchangeably herein. A database image may include one or more database objects. A relational database management system (RDMS) or the equivalent may execute storage and retrieval of information against the database object(s). Application platform 18 may be a framework that allows the applications of system 16 to run, such as the hardware and/or software, e.g., the operating system. In an embodiment, on-demand database service 16 may include an application platform 18 that enables creation, managing and executing one or more applications developed by the provider of the on-demand database service, users accessing the on-demand database service via user systems 12, or third party application developers accessing the on-demand database service via user systems 12.

The users of user systems 12 may differ in their respective capacities, and the capacity of a particular user system 12 might be entirely determined by permissions (permission levels) for the current user. For example, where a salesperson is using a particular user system 12 to interact with system 16, that user system has the capacities allotted to that salesperson. However, while an administrator is using that user system to interact with system 16, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 14 is any network or combination of networks of devices that communicate with one another. For example, network 14 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the present invention might use are not so limited, although TCP/IP is a frequently implemented protocol.

User systems 12 might communicate with system 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP messages to and from an HTTP server at system 16. Such an HTTP server might be implemented as the sole network interface between system 16 and network 14, but other techniques might be used as well or instead. In some implementations, the interface between system 16 and network 14 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 16, shown in FIG. 1, implements a web-based customer relationship management (CRM) system. For example, in one embodiment, system 16 includes application servers configured to implement and execute CRM software applications (application processes) as well as provide related data, code, forms, web pages and other information to and from user systems 12 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

One arrangement for elements of system 16 is shown in FIG. 1, including a network interface 20, application platform 18, tenant data storage 22 for tenant data 23, system data storage 24 for system data 25 accessible to system 16 and possibly multiple tenants, program code 26 for implementing various functions of system 16, and a process space 28 for executing MTS system processes and tenant-specific processes, such as running applications as part of an application hosting service. Additional processes that may execute on system 16 include database indexing processes.

Several elements in the system shown in FIG. 1 include conventional, well-known elements that are explained only briefly here. For example, each user system 12 could include a desktop personal computer, workstation, laptop, PDA, cell phone, or any wireless access protocol (WAP) enabled device or any other computing device capable of interfacing directly or indirectly to the Internet or other network connection. User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and applications available to it from system 16 over network 14. Each user system 12 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 16 or other systems or servers. For example, the user interface device can be used to access data and applications hosted by system 16, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 12 and all of its components are operator configurable using applications, such as a browser, including computer code run using a central processing unit such as an Intel Pentium® processor or the like. Similarly, system 16 (and additional instances of an MTS, where more than one is present) and all of their components might be operator configurable using application(s) including computer code to run using a central processing unit such as processor system 17, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 16 to intercommunicate and to process web pages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments of the present invention can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 2 also illustrates environment 10. However, in FIG. 2 elements of system 16 and various interconnections in an embodiment are further illustrated. FIG. 2 shows that user system 12 may include processor system 12A, memory system 12B, input system 12C, and output system 12D. FIG. 2 shows network 14 and system 16. FIG. 2 also shows that system 16 may include tenant data storage 22, tenant data 23, system data storage 24, system data 25, User Interface (UI) 30, Application Program Interface (API) 32, PL/SOQL 34, save routines 36, application setup mechanism 38, applications servers 100₁-100_{N}, system process space 102, tenant process spaces 104, tenant management process space 110, tenant storage area 112, user storage 114, and application metadata 116. In other embodiments, environment 10 may not have the same elements as those listed above and/or may have other elements instead of, or in addition to, those listed above.

User system 12, network 14, system 16, tenant data storage 22, and system data storage 24 were discussed above in FIG. 1. Regarding user system 12, processor system 12A may be any combination of one or more processors. Memory system 12B may be any combination of one or more memory devices, short term, and/or long term memory. Input system 12C may be any combination of input devices, such as one or more keyboards, mice, trackballs, scanners, cameras, and/or interfaces to networks. Output system 12D may be any combination of output devices, such as one or more monitors, printers, and/or interfaces to networks. As shown by FIG. 2, system 16 may include a network interface 20 (of FIG. 1) implemented as a set of HTTP application servers 100, an application platform 18, tenant data storage 22, and system data storage 24. Also shown is system process space 102, including individual tenant process spaces 104 and a tenant management process space 110. Each application server 100 may be configured to tenant data storage 22 and the tenant data 23 therein, and system data storage 24 and the system data 25 therein to serve requests of user systems 12. The tenant data 23 might be divided into individual tenant storage areas 112, which can be either a physical arrangement and/or a logical arrangement of data. Within each tenant storage area 112, user storage 114 and application metadata 116 might be similarly allocated for each user. For example, a copy of a user's most recently used (MRU) items might be stored to user storage 114. Similarly, a copy of MRU items for an entire organization that is a tenant might be stored to tenant storage area 112. A UI 30 provides a user interface and an API 32 provides an application programmer interface to system 16 resident processes to users and/or developers at user systems 12. The tenant data and the system data may be stored in various databases, such as one or more Oracle™ databases.

Application platform 18 includes an application setup mechanism 38 that supports application developers' creation and management of applications, which may be saved as metadata into tenant data storage 22 by save routines 36 for execution by subscribers as one or more tenant process spaces 104 managed by tenant management process 110 for example. Invocations to such applications may be coded using PL/SOQL 34 that provides a programming language style interface extension to API 32. A detailed description of some PL/SOQL language embodiments is discussed in commonly owned co-pending U.S. Provisional Patent Application 60/828,192 entitled, PROGRAMMING LANGUAGE METHOD AND SYSTEM FOR EXTENDING APIS TO EXECUTE IN CONJUNCTION WITH DATABASE APIS, by Craig Weissman, filed Oct. 4, 2006, which is incorporated in its entirety herein for all purposes. Invocations to applications may be detected by one or more system processes, which manages retrieving application metadata 116 for the subscriber making the invocation and executing the metadata as an application in a virtual machine.

Each application server 100 may be communicably coupled to database systems, e.g., having access to system data 25 and tenant data 23, via a different network connection. For example, one application server 100₁ might be coupled via the network 14 (e.g., the Internet), another application server 100_{N-1} might be coupled via a direct network link, and another application server 100_{N} might be coupled by yet a different network connection. Transfer Control Protocol and Internet Protocol (TCP/IP) are typical protocols for communicating between application servers 100 and the database system. However, it will be apparent to one skilled in the art that other transport protocols may be used to optimize the system depending on the network interconnect used.

In certain embodiments, each application server 100 is configured to handle requests for any user associated with any organization that is a tenant. Because it is desirable to be able to add and remove application servers from the server pool at any time for any reason, there is preferably no server affinity for a user and/or organization to a specific application server 100. In one embodiment, therefore, an interface system implementing a load balancing function (e.g., an F5 Big-IP load balancer) is communicably coupled between the application servers 100 and the user systems 12 to distribute requests to the application servers 100. In one embodiment, the load balancer uses a least connections algorithm to route user requests to the application servers 100. Other examples of load balancing algorithms, such as round robin and observed response time, also can be used. For example, in certain embodiments, three consecutive requests from the same user could hit three different application servers 100, and three requests from different users could hit the same application server 100. In this manner, system 16 is multi-tenant, wherein system 16 handles storage of, and access to, different objects, data and applications across disparate users and organizations.

As an example of storage, one tenant might be a company that employs a sales force where each salesperson uses system 16 to manage their sales process. Thus, a user might maintain contact data, leads data, customer follow-up data, performance data, goals and progress data, etc., all applicable to that user's personal sales process (e.g., in tenant data storage 22). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 16 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 16 might also maintain system level data usable by multiple tenants or other data. Such system level data might include industry reports, news, postings, and the like that are sharable among tenants.

In certain embodiments, user systems 12 (which may be client systems) communicate with application servers 100 to request and update system-level and tenant-level data from system 16 that may require sending one or more queries to tenant data storage 22 and/or system data storage 24. System 16 (e.g., an application server 100 in system 16) automatically generates one or more SQL statements (e.g., one or more SQL queries) that are designed to access the desired information. System data storage 24 may generate query plans to access the requested data from the database.

A table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system.

### E-Mail to Case

One drawback for users of on-demand services providing customer service and support functionality is that some functionality exists on a server on-(customer) premise. For example, systems that allow users of on-demand services to send electronic messages to a case, also know as “Email To Case” systems may include one or more applications (e.g., a Java application) installed on customer supported equipment. As such, customers are required to maintain additional software and/or hardware, such as an email server, to work with the on-demand service. This is limiting due to the fact that the customers wish to migrate to the on-demand service to reduce such constraints.

According to one embodiment, system 16 may include On-Demand Email To Case functionality. In one example, an On-Demand Email To Case module can be provided that includes at least two components: a first component (e.g., code) that handles emails and related processing and a second component for configuring email handling. In certain aspects, the first component can provide a vast inbound email capability, such as passing inbound emails directly to one or more Apex methods for handling. The second component may include one or more user interfaces (e.g., a setup screen) in which individual email addresses and other information and settings may be established and/or modified.

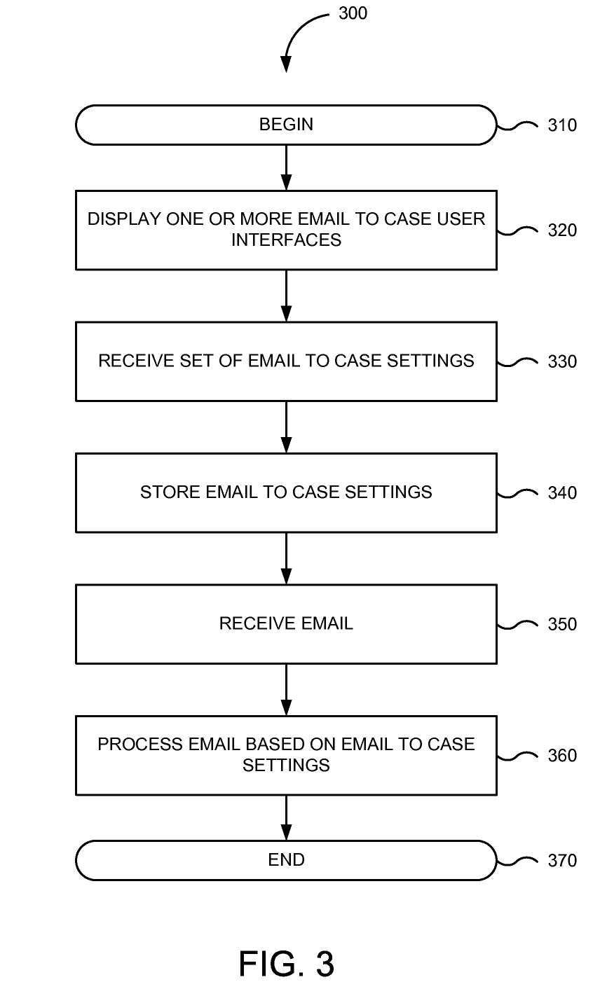

FIG. 3 is a flowchart of method 300 for providing Email To Case functionality in an on-demand service according to an embodiment of the present invention. Implementations of or processing in method 300 depicted in FIG. 3 may be performed by software (e.g., instructions or code modules) when executed by a central processing unit (CPU or processor) of a logic machine, such as a computer system or information processing device, by hardware components of an electronic device or application-specific integrated circuits, or by combinations of software and hardware elements. Method 300 depicted in FIG. 3 begins in step 310.

In step 320, one or more Email To Case user interfaces are displayed. In some embodiments, one or more on-demand services provided by system 16 may send or otherwise cause to be forwarded information configured for displaying one or more user interfaces on user system 12. The one or more Email To Case user interfaces may be generated based on traditional window management APIs, markup languages (e.g., HTML, XML), JAVA, or the like. The Email To Case user interfaces may include command line features and/or graphical user interface (GUI) features. Some examples of GUI features may include GUI elements such as controls, widgets, images, text boxes, drop down lists, check boxes, radio buttons, scroll controls, and the like.

In step 330, a set of Email To Case settings are received. In one example, one or more users of user system 12 may interact via network 14 with one or more on-demand services provided by system 16 to create or modify one or more Email To Case settings. Some examples of Email To Case settings can include:

Routing Address: A setting for an email address for which handling is desired (e.g., support@mycompany.com).

Email Services Address: A setting for a system-defined Email Services address to which a Routing Address will be forwarded. In various embodiments, at least one Email Services Address may be defined per Routing Address.

Save Headers: A setting for defining whether email headers or related metadata should be saved.

Create Task From Email: A setting for defining whether a Task should be created when an email arrives.

Autocreated Task Status: A setting for defining a status for an automatically created tasks. In certain aspects, automatic task creation may create a Task having a specified status, such as open, closed, waiting, etc. In certain aspects, the setting may be implemented using one or more dropdown list synced with predefined or user-specified case statuses.

Notify Case Owners On New Emails: A setting for defining whether to notify a case owner. For example, when an email arrives on an existing case, a determination may be made based on the setting whether the case owner should be notified. In certain aspects, a user may designate one or more one or more predefined or user-created email templates for a notification email.

Enable HTML Email: A setting for defining whether to warn users of incoming HTML email content before they view the incoming HTML email content. This setting facilitates security in that users can more readily avoid opening potentially malicious HTML that could harm their computers. With this setting disabled, users may see text instead of HTML on email message detail pages, and when users reply to an email, the text version of the email will be copied to the email editor, instead of the HTML version.

Priority: A setting for defining a priority of a created case. A determination may be made based on the setting to set a Priority field. In certain aspects, the setting may be implemented using one or more dropdown list synced with predefined or user-specified case priorities.

Case Origin: A setting for defining the original of a created case. A determination may be made based on the setting to set a Case Origin field. In certain aspects, the setting may be implemented using one or more dropdown list synced with predefined or user-specified case origins.

Case Record Type: A setting for defining a type of a created case. A determination may be made based on the setting to set a Case Record Type field. In certain aspects, the setting may be implemented using one or more dropdown list synced with predefined or user-specified case record types.

In various embodiments, one or more settings may be created or modified based on a default value or setting. For example, email headers may occupy up to 75% of overall storage. In most cases, the email headers don't need to be stored as the metadata may have already been propagated to other system objects, e.g., email objects. As such, a setting to store email headers may default to false. In some embodiments, creating or modifying a setting may result in one or more warnings or notifications. For example, when a user attempts to enable the saving of email headers, a warning may be shown informing the user of the significant contribution to storage usage that may result.

Returning to FIG. 3, in step 340, the Email To Case settings are stored. For example, system 16 may store the Email To Case settings in a database. The settings may be stored as part of a user's or organization's profile.

In step 350, an email is received. For example, system 16 may receive an email in an inbox associated with an Email Services Address that was sent to a Routing Address and forwarded to the Email Services Address. In step 360, the email is processed or otherwise handled based on the stored Email To Case settings.

According to one embodiment, when an email arrives, On-Demand Email to Case code (e.g., the first component that handles emails and related processing of system 16) can take the following steps:

1a. Perform a regex parse on the email to determine whether a thread ID is present.

1b. If a thread ID is not present, search for a case number in the Subject.

2a. If the thread ID or case number is present, parse the thread ID or case number and obtain the ID of the corresponding case.

2b. If the thread ID or case number is not present, create a new Case based on stored Email To Case settings defining a routing address in a corresponding setup object. In some embodiments, the created case can be subject to assignment rules. Apex code may look for a Contact where the email address matches the address in the From address. If exactly one Contact is found, that Contact and its corresponding Account can be set on the case.

3. Create a Task based on stored Email To Case settings defining a status specified in the setup object, the subject of the email, and the body of the email in the description field.

4. Create an EmailMessage object with a TaskId of the created task and with a ParentId of the Case that was either created or discovered in step 2.

5. If this is a thread on an existing case and the setup object is set to notify the case owner, forward the email to a case owner.

FIG. 3 ends in step 370.

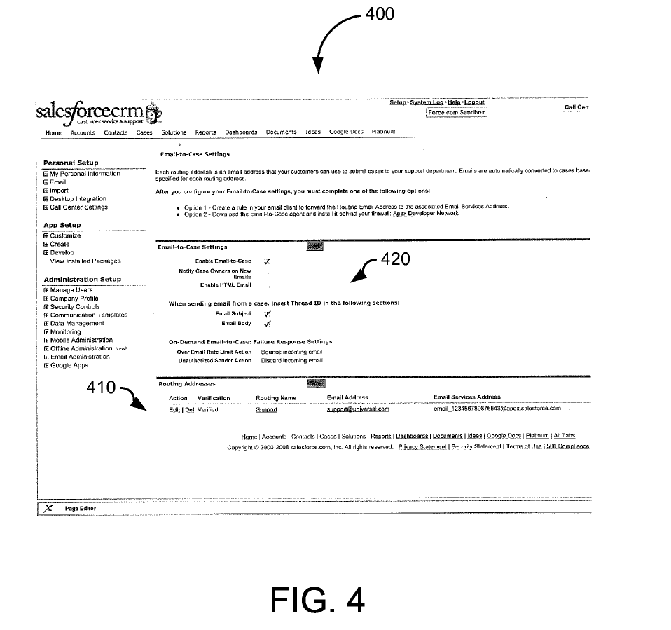

FIG. 4 is a screenshot of user interface 400 for creating and/or modifying Email To Case settings for system 16 according to an embodiment of the present invention. In this example, user interface 400 may be embodied as a web page, a user interface generated by an application, or the like. User interface 400 may include settings section 410 and settings section 420.

Settings section 410 can include information relevant to configuring one or more source and destination addresses. Settings section 410 may include one or more options, features, selections, controls, or the like for creating entries in settings section 410. An entry in settings section 410 may include a setting for an email address for which handling is desired (e.g., support@mycompany.com) and a setting for a system-defined Email Services address to which a Routing Address will be forwarded. An entry in settings section 410 may include an association or mapping between a designated Routing Address and a Email Services Address.

Settings section 420 can include information relevant to configuring one or more settings or options that apply to entries in settings section 410. The one or more settings or options may include a setting for enabling or disabling an entry or entries, a setting for defining whether to notify a case owner, a setting for defining whether to warn users of incoming HTML email content before they view the incoming HTML email content, or the like. Settings section 420 may include one or more options, features, selections, controls, or the like.

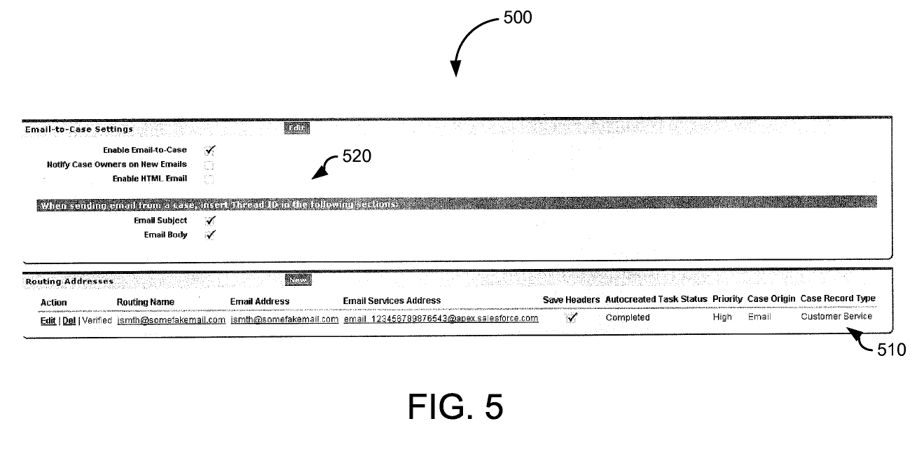

FIG. 5 is a screenshot of user interface 500 for creating and/or modifying Email To Case settings for system 16 according to an embodiment of the present invention. In this example, user interface 500 may be embodied as a web page, a user interface generated by an application, or the like. User interface 500 may include settings section 510 similar to settings section 410 of FIG. 4 and settings section 520 similar to settings section 420 of FIG. 4.

Settings section 510 can include information relevant to configuring one or more source and destination addresses. Settings section 510 may include one or more options, features, selections, controls, or the like for creating entries in settings section 510. An entry in settings section 510 may include a setting for defining whether email headers or related metadata should be saved, a setting for defining whether a Task should be created when an email arrives, a setting for defining a status for an automatically created tasks, a setting for defining a priority of a created case, a setting for defining the original of a created case, a setting for defining a type of a created case, or the like. Settings section 520 can include information relevant to configuring one or more options that apply to entries in settings section 510. Settings section 520 may include one or more options, features, selections, controls, or the like.

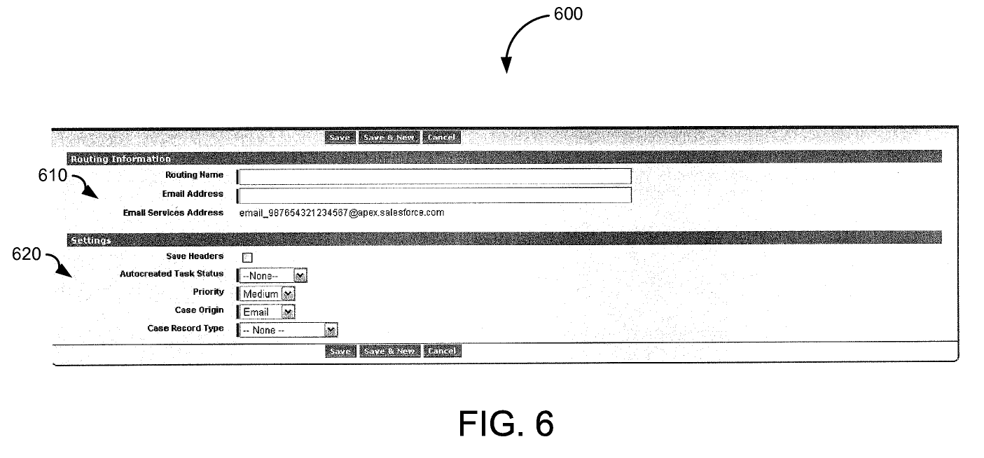

FIG. 6 is a screenshot of user interface 600 for creating and/or modifying Email To Case settings for system 16 according to an embodiment of the present invention. In this example, user interface 600 may be embodied as a web page, a user interface generated by an application, or the like. User interface 600 may include settings section 610 similar to settings section 510 of FIG. 5 and settings section 620 similar to settings section 520 of FIG. 5.

### Error Handling

In various embodiments, system 16 may include On-Demand Email To Case error handling functionality. Additional functionality for handling exceptions may be created or modified using one or more user interfaces.

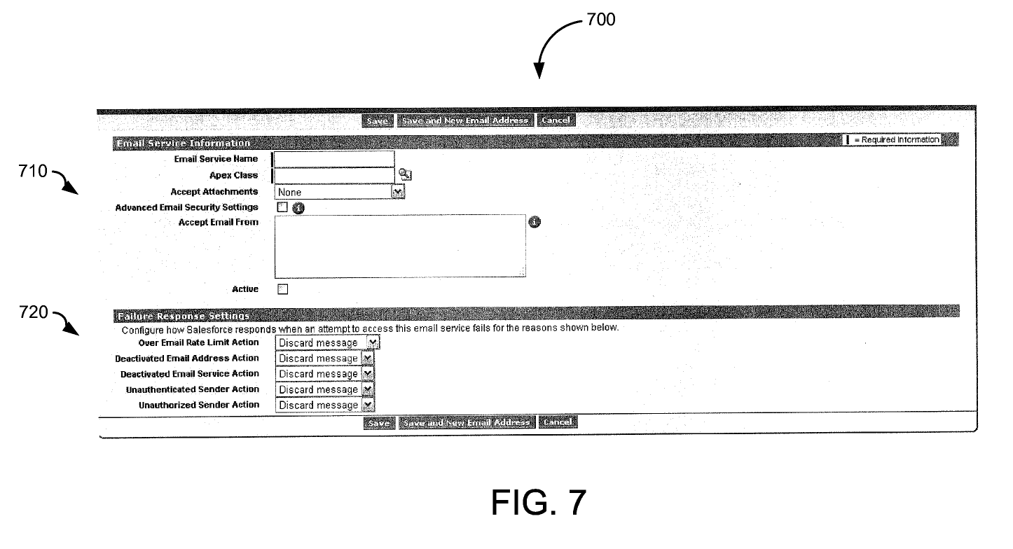

FIG. 7 is a screenshot of user interface 700 for creating and/or modifying Email To Case settings for system 16 according to an embodiment of the present invention. In this example, user interface 700 may be embodied as a web page, a user interface generated by an application, or the like. User interface 700 may include settings section 710 and settings section 720.

Settings section 710 can include information relevant to configuring or identifying an Email To Case service. One or more settings in settings section 710 may include a settings for identifying an email service, a setting for an Apex class, a setting for whether the service accepts attachments, a setting for defining whitelists, blacklists, or graylists, a setting for enabling or disabling a service, or the like.

Settings section 720 can include information relevant to configuring or identifying failure responses for an Email To Case service. One or more settings in settings section 710 may include a settings for configuring actions to be performed in response to errors or failures, such as a setting defining how to handle oversized emails, a setting defining how to handle deactivated email addresses, a setting defining how to handle deactivated services, a setting defining how to handed unauthenticated senders, a setting defining how to handle unauthorized senders, or the like.

In one example, one or more users of user system 12 may interact via network 14 with one or more on-demand services provided by system 16 to create or modify one or more Email To Case settings. Some examples of Email To Case error handling settings can include:

Email Size Limit Action: A setting for specifying, if an email is too big, an option to truncate the email so that it meets the size restrictions without failing.

Email Template: A setting for defining an email template to format bounce messages. This can allow users to brand the email and present a more consumable error to their customers (e.g., so that email appears to come from company A, for example, instead of system 16).

Bounce: A setting for defining, if an email is going to bounce, an option to bounce the email to an administrator (or another specified email address) instead of the customer. In certain aspects, this is in concert with the Email Template.

In some embodiments, these error handling options can be located in or otherwise accessible via an Email to Case setup screen. For example, an Error Handling section may be provided with a Routing Addresses detail view.

### Portal Super User

Generally, a portal is an interface that allows the general public access to a subset of data available at an on-demand database service, such as system 16. Normally such data is accessible only to explicitly licensed users (customers of the on-demand service), but via a portal, people who do not explicitly pay for a license (e.g., non-employees of an organization that is a licensee) can access a subset of a given user's data that pertains to them, for instance their own cases.

User's of an on-demand database service may desire that some people who do not explicitly pay for a license (for example, an administrator or a support manager) be able to view all Cases under an Account, rather than simply their own cases. These users may need to be able to view all Contacts and Users that belong to the Account. In addition, user's of an on-demand database service may desire that all users for a given Account be able to see all related Cases even if they are not the Contact on the Case (this is a common high tech support use case).

According to one embodiment, system 16 may include Portal Super User functionality. In one example, one or more manual sharing rules may be created on an account to a portal role related to the account. With this approach, however, a manual share may need to be created for each portal enabled account. This can be a big administrative task when 1,000's and 10,000's of accounts are involved. Additionally, manual sharing rules may be deleted when an account owner changes and end users (e.g., sales reps) may delete manual shares set up by the portal role related to the account.

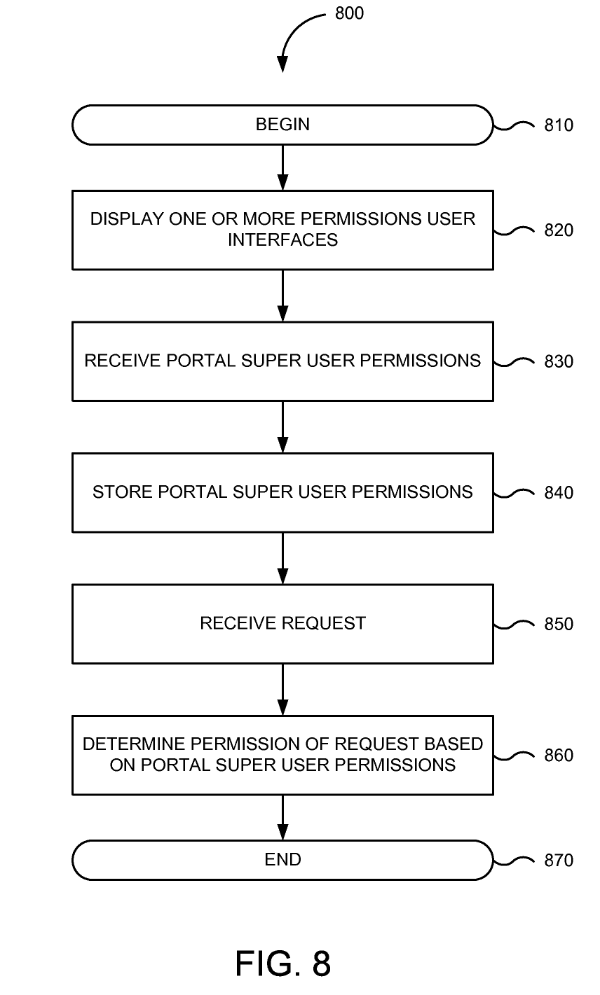

FIG. 8 is a flowchart of method 800 for providing Portal Super Users in an on-demand service according to an embodiment of the present invention. Implementations of or processing in method 800 depicted in FIG. 8 may be performed by software (e.g., instructions or code modules) when executed by a central processing unit (CPU or processor) of a logic machine, such as a computer system or information processing device, by hardware components of an electronic device or application-specific integrated circuits, or by combinations of software and hardware elements. Method 800 depicted in FIG. 8 begins in step 810.

In step 820, one or more permissions user interfaces are displayed. In some embodiments, one or more on-demand services provided by system 16 may send or otherwise cause to be forwarded information configured for displaying one or more user interfaces on user system 12. The one or more permissions user interfaces may be generated based on traditional window management APIs, markup languages (e.g., HTML, XML), JAVA, or the like. The Case Teams user interfaces may include command line features and/or graphical user interface (GUI) features. Some examples of GUI features may include GUI elements such as controls, widgets, images, text boxes, drop down lists, check boxes, radio buttons, scroll controls, and the like.

In step 830, Portal Super User permissions are received. In one example, one or more users of user system 12 may interact via network 14 with one or more on-demand services provided by system 16 to create or modify one or more Portal Super User permissions. In various embodiments, a Portal Super User can be defined at the profile level for customer portal profiles. The Portal Super User may be a setting or permission provided to another user. When Portal Super User is activated/on for a user, that user is able to see his own account (subject of course to the page layout granted him on Account), and is able to see all contacts and cases under his account. A user interface for a Portal Super User, in certain aspects, may include a profile permission that is available to portal profiles, such as a single profile permission called “Customer Portal Super User” or the like.

The readability and writeability of contacts and cases under a portal super user's account may be controlled by settings on those objects in a user's profile (e.g., CRUD—Create, Read, Update, Delete—the set of permissions that a user can have when interacting with data). If a profile provides update access to a Contact or Case, then those objects are editable. In certain aspects, a Portal Super User setting can be turned on by default whenever a Delegated Portal Administrator profile permission is on. In that event, the Portal Super User setting may not be disabled in certain aspects. In certain aspects, users with Portal Super User permission can have the capability to see other accounts, custom objects, contacts and cases if those objects have been explicitly shared to them. Custom objects are not subject to “super usage”—for all custom objects, a normal sharing model applies equally to super users as to regular users.

Therefore, in addition to everything a normal portal user can do, super portal user allows users to create/view/edit all Cases in channel (under user's Account) and view/edit Contacts in Account without having to create manual sharing rules for each Account which are deleted when the account owner changes.

Returning to FIG. 8, in step 840, the Portal Super User permissions are stored. For example, system 16 may store the Portal Super User permissions in a database. In step 850, a request is received. For example, system 16 may receive a request from a user of user system 12 to access data. In step 860, permissions of the request is determined based on the stored Portal Super User permissions settings. FIG. 8 ends in step 870.

### Case Teams

An on-demand database service, such as provided by system 16, may include a web-based platform that gives users the ability to collaborate, both internally (such as between employees of a user organization) and externally (such as with customers of a user organization). It can be advantageous for customers to collaborate on cases as the collaboration base grows. In various embodiments, system 16 may include Case Teams functionality. In one example, a team of people may be created to include agents, other employees, portal users, contacts, and even non-contacts allowing all collaborators to work cases more efficiently while providing up-to-date information to interested parties.

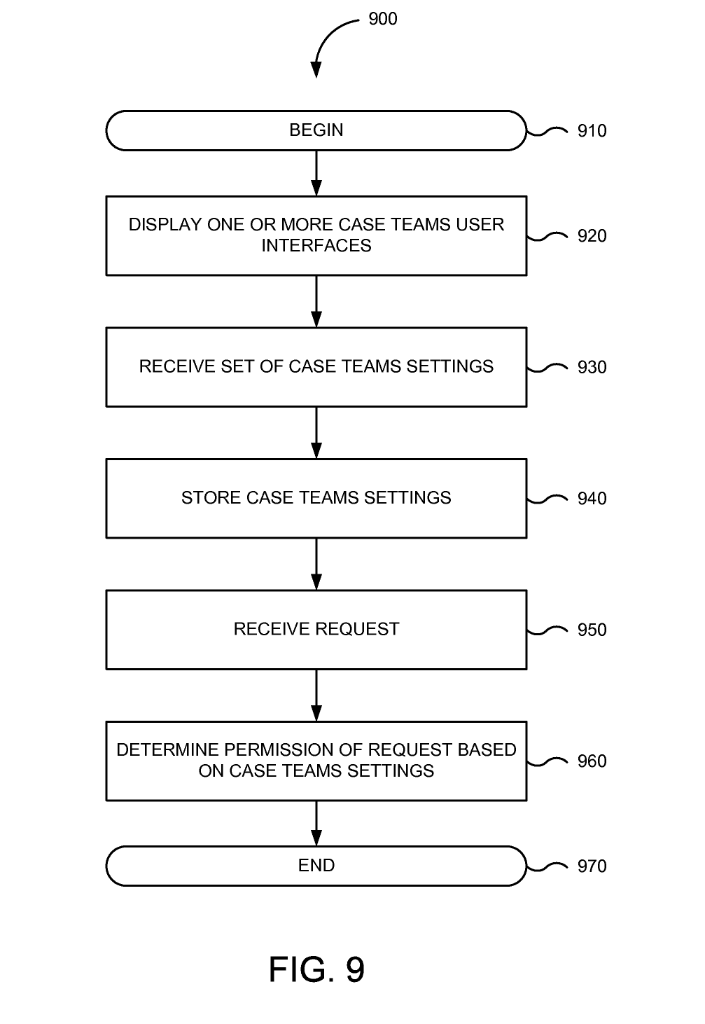

FIG. 9 is a flowchart of method 900 for providing Case Teams in an on-demand service according to an embodiment of the present invention. Implementations of or processing in method 900 depicted in FIG. 9 may be performed by software (e.g., instructions or code modules) when executed by a central processing unit (CPU or processor) of a logic machine, such as a computer system or information processing device, by hardware components of an electronic device or application-specific integrated circuits, or by combinations of software and hardware elements. Method 900 depicted in FIG. 9 begins in step 910.

In step 920, one or more Case Teams user interfaces are displayed. In some embodiments, one or more on-demand services provided by system 16 may send or otherwise cause to be forwarded information configured for displaying one or more user interfaces on user system 12. The one or more Case Teams user interfaces may be generated based on traditional window management APIs, markup languages (e.g., HTML, XML), JAVA, or the like. The Case Teams user interfaces may include command line features and/or graphical user interface (GUI) features. Some examples of GUI features may include GUI elements such as controls, widgets, images, text boxes, drop down lists, check boxes, radio buttons, scroll controls, and the like.

In step 930, a set of Case Teams settings are received. In one example, one or more users of user system 12 may interact via network 14 with one or more on-demand services provided by system 16 to create or modify one or more Case Teams settings. Some examples of Case Teams settings can include:

Members: A setting defining members of a Case Team. In certain aspects, the following may be eligible to be members: Users, Queues, Customer Portal Users, Partner Portal Users, and Contacts (with no associated Users). In one embodiment, a Case Owner may be automatically made a member of a Case Team. The sharing settings of the Case Owner may not be modifiable. In another embodiment, Users can add members to a Case Team for a Case on an ad hoc basis (e.g., by pressing an Add button on a Case Teams related list). In certain aspects, an Add button used to add ad hoc team members may also provide capability to add a Predefined Case Team, which would add all the members of that Predefined Case Team to the Case.

Case Team Role: A setting that defines individuals' responsibilities with respect to a Case. Case Team Roles may be definable by administrators (e.g., those with a Customize Application permission).

As roles will differ widely between businesses, in some embodiments, Case Team Roles can be selected from a dynamic picklist. In certain aspects, the picklist can be populated with the following values shown in Table 1:

TABLE 1

| Role | Default? | Notification | Sharing | Visibility |
|---|---|---|---|---|
| Support Rep | Y | All | Read/ | Customer |
| | | | Write | Portal |
| Engineer | N | All | Read | Private |
| Primary | N | Public Comments, | Read | Customer |
| Customer | | Status Changes | | Portal |
| Contact | | | | |
| Interested Party | N | Public Comments | Read | Customer |
| | | | | Portal |

In certain aspects, a Case Team Role user interface may be provided that allows an administrator to define the following settings on a Case Team Role:

Notifications: A settings for notifications for a given role.

Sharing: A settings defining sharing for a given role.

Visibility: A setting defining visibility for a given role.

One of the primary purposes of Case Teams can include notifications of interested parties. In certain aspects, a notifications setting for Case Teams may include the following different types of notifications, and others: Emails, Comments, Activities, Status Changes, Case Closure (defined as a status change where the new status is a Closed status), or the like.

In some embodiments, notifications can be represented as a multiselect picklist on a Case Team Role. Therefore, a team member's notifications may be driven based on their roles. In certain aspects, it is possible to select none of these notifications. This will allow members to be shared the case, but not notified about the case. In some embodiments, if Emails, Comments or Activities are selected but the member is a Customer Portal User or Contact, then that member may only be notified for public EmailMessages, Comments and Activities. If Status Changes is selected, Case Closure may have no additional effect as Case Closure may be a subset of Status Changes.

In further embodiments, an administrator may make choose whether Case Team members are immediately notified upon their addition to a Case Team. If the administrator selects such an option, an email template with which the new Case Team member will be notified can be selected. If a notification is not set for immediate notification as above, then the notification may be added to a daily digest. A daily digest can include an email sent daily to all people who have any pending notifications, and may contain all the notifications that have queued up to that time. In certain aspects, these notifications can be sent at a time each day that is selectable by an administrator.

A sharing setting can be applicable if a Case Team member in question is a User. Otherwise, sharing may not be available. Sharing Settings may also be driven from a Case Team member's role. In certain aspects, the Sharing Settings includes a picklist including the following values: None, Read Only, Read/Write, Full Access, or the like.

When the addition of case team members calls for new shares to be made, sharing rows with special properties may be created in the Case Share table. Specifically, these may be implicit sharing rows—queryable on a CaseShare table via an API, but not updateable or deleteable. These rows can be modified by modifying a corresponding CaseTeamMember row.

Support organizations frequently want to create case teams where some of the members are not visible to the general public. A Visibility Setting of each case team member can define what portal users can see those members, if any. Visibility Settings can also be driven from the Case Team member's role. In certain aspects, Visibility Settings includes a picklist with the following values: Internal Only, Internal and Partner Portal, Internal, and All Portals, or the like.

In various embodiments, a case owner, his managers in the role hierarchy, administrators, and the system (in the form of assignment rules or Apex)—basically anyone who has Full Access to the case—can modify a Case Team on a Case. Upon User inactivation, that User is optionally removed from all Case Teams and Predefined Case Teams in which he is participating. This option may be provided as part of a second step of a User deactivation wherein an administrator is asked whether that user should be removed from Case Teams. Upon Contact deletion, that Contact is removed from all Case Teams and Predefined Case Teams in which he is participating.

Returning to FIG. 9, in step 940, the Case Teams settings are stored. For example, system 16 may store the Case Teams settings in a database. In step 950, a request is received. For example, system 16 may receive a request from a user of user system 12 to access data. In step 960, permissions of the request is determined based on the stored Case Teams settings. FIG. 9 ends in step 970.

### Predefined Case Teams (aka Team Templates)

In some embodiments, system 16 may provide Predefined Case Team functionality. A Predefined Case Team can include a set of Case Team members which has been predefined and which can be applied to a Case Team en masse. A Predefined Case Team can contain all the elements of a standard Case Team: the notification settings, sharing settings, and the visibility settings.

If a case team is changed, an administrator may be presented the option to modify all Case Teams such that these changes propagate out. A Case Team member may retain a “memory” of which Predefined Case Team defined it. Then, users that came from this team can be queried and modifications made to their team membership on affected cases.

A Case Team member who has been added to the case as part of a case team can nonetheless be changed individually by the case owner. In the event that a Case Team member is changed from the default defined in his entry in the Predefined Case Team, the link between that Case Team member and his Predefined Case Team is severed, and that Case Team member is treated as an ad hoc member from that point forward.

Assignment rule entries can be amended such that there is a new section below the user/queue assignment area where Case Teams can be assigned. Here, one is capable of adding one or more Predefined Case Teams. In certain aspects, the option is given to replace the Case Team if a Case Team already exists on the case (as when it's being reassigned). If this option is selected, the Case Team from the assignment rule entry replaces the team on the case. If this option is not selected, any Case Team members from the assignment rule entry are added to the Case Team.

In certain aspects, the Case Teams section of assignment rule entries also makes an additional provision for Account Teams. Specifically, there is provided a means of specifying that any Account Team member with a given role should be added to the team, and specifying the notification, sharing and visibility settings for team members added from that role. If an Account Team role is deleted, its corresponding entries in Assignment Rule Entries also is deleted.

In certain aspects, an option is provided to the Change Account Team page to allow users to replace or delete members from all Case Teams if those members are modified or deleted in the Account Team. These changes affect cases that are associated with the Account for which the team is being changed. These updates are not applicable to Case Team Members who were added to the team as part of a Predefined Case Team.

In certain aspects, an entry is provided to the View dropdown for reports on Case called “Cases Where I'm A Member Of The Team” or something similar. This will restrict the set of cases in the report to only those cases where the running user is a member of the team. A report is also added that will show all cases where the running user is a member of the case team. A report is also added that will show all open cases where the running user is a member of the case team. A standard report type “Case Teams With Cases” is also provided to the Customer Support Reports report type so that users can create custom Case Team to Case reports.

In one embodiment, an object, CaseTeam, is added to an API of system 16 as a container for predefined case teams, an object, CaseTeamRole, is added to the API or the Metadata API to contain org-defined roles and corresponding default notification and sharing settings, and an object, CaseTeamMember, is added to the API. All of these objects are Apex-triggerable in certain aspects.

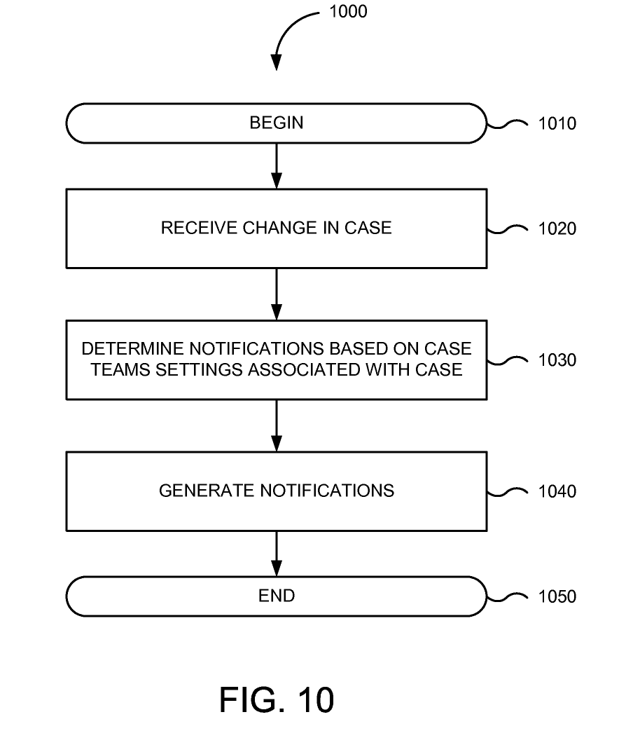

FIG. 10 is a flowchart of method 1000 for generating notification based on Case Teams settings in an on-demand service according to an embodiment of the present invention. Implementations of or processing in method 1000 depicted in FIG. 10 may be performed by software (e.g., instructions or code modules) when executed by a central processing unit (CPU or processor) of a logic machine, such as a computer system or information processing device, by hardware components of an electronic device or application-specific integrated circuits, or by combinations of software and hardware elements. Method 1000 depicted in FIG. 10 begins in step 1010.

In step 1020, a change in a case is received. For example, a major social networking company may use an on-demand service such system 16 for its customer support operations. On some occasions they may receive cases regarding child endangerment. In these cases, they need to ensure that the following people are notified upon changes to the case:

The filer of the case (who may or may not be a customer portal user)

The company's legal department (who may or may not be users)

The attorney general's office of the state in which the case was filed (who will be a Contact)

In step 1030, notifications are determined based on Case Teams settings associated with the case. Different interested parties will have different needs for notification. The company's legal department may wish to see every comment or email pertaining to this case, whereas the attorney general's office, for example, may be interested only in seeing the case closed. Meanwhile, portal users who should see the case via the portal should be allowed to do so. Case Teams allows the appropriate notification.

In step 1040, one or more notifications are generated. In one embodiment, the generated notifications can vary in content based on notification settings. In another embodiment, the number of generated notification may vary. FIG. 10 ends in step 1050.

### Holidays Incorporated in Business Hours

According to one embodiment, system 16 may include enhanced Holiday determination functionality. As holidays can be frequently shared across sets of Business Hours, a Holidays object may be linked to a Business Hours object via a transparent many-to-many related list. In certain aspects, a “pool” of holidays from which administrators can pick and choose when setting up a new set of Business Hours is provided.

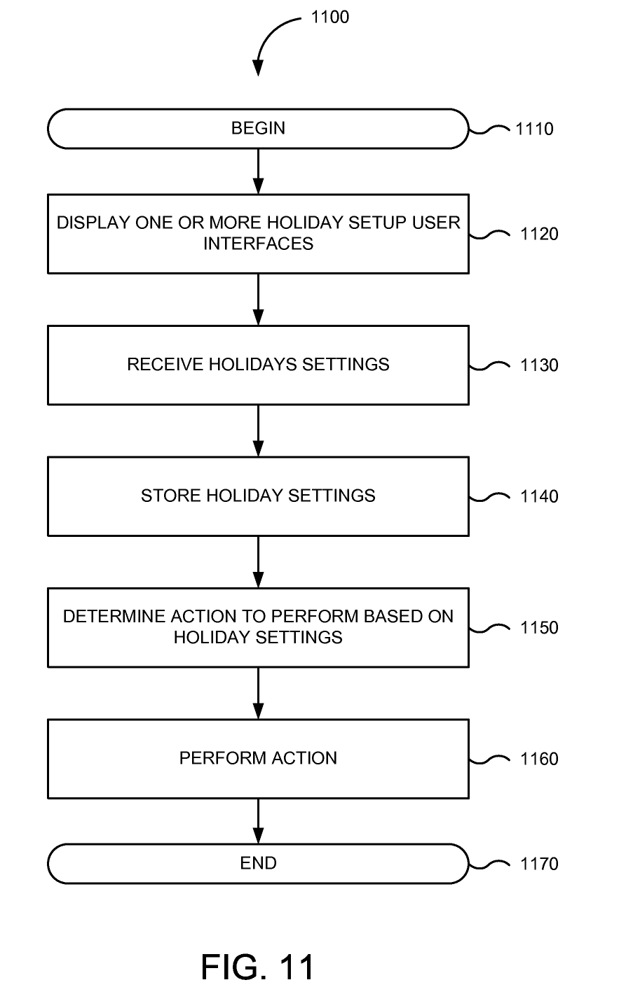

FIG. 11 is a flowchart of method 1100 for performing actions based on Holidays settings in an on-demand service according to an embodiment of the present invention. Implementations of or processing in method 1100 depicted in FIG. 11 may be performed by software (e.g., instructions or code modules) when executed by a central processing unit (CPU or processor) of a logic machine, such as a computer system or information processing device, by hardware components of an electronic device or application-specific integrated circuits, or by combinations of software and hardware elements. Method 1100 depicted in FIG. 11 begins in step 1110.

In step 1120, one or more Holidays user interfaces are displayed. In some embodiments, one or more on-demand services provided by system 16 may send or otherwise cause to be forwarded information configured for displaying one or more user interfaces on user system 12. The one or more Holidays user interfaces may be generated based on traditional window management APIs, markup languages (e.g., HTML, XML), JAVA, or the like. The Holidays user interfaces may include command line features and/or graphical user interface (GUI) features. Some examples of GUI features may include GUI elements such as controls, widgets, images, text boxes, drop down lists, check boxes, radio buttons, scroll controls, and the like.

In step 1130, a set of Holidays settings are received. In one example, one or more users of user system 12 may interact via network 14 with one or more on-demand services provided by system 16 to create or modify one or more Holidays settings. A Holidays object may include a different section of a setup tree so that holidays can be set up generically. In addition, a button may be provided on a Business Hours page to add a new holiday on the fly.

In various embodiments, Holidays can be definable on an individual day or repeatable basis. For example, an admin could create a holiday that is Dec. 25, 2008, or he could create one that is every December 25. It is left to the user to decide at what level of granularity this repeatability should be allowed; the greatest granularity possible is desired. Holidays are preferably definable using a “from” datetime and a “to” datetime, thereby giving administrators or other users the capability to define partial-day holidays.

Reference is made to U.S. Provisional Patent Application No. 61/051,166, entitled “Method and System for Managing Multiple Business Hours in an On-Demand Services”, which is hereby incorporated by reference, for additional details on Business Hours objects and functionality.

Returning to FIG. 11, in step 1140, the Holidays settings are stored. In step 1150, an action to be performed is determined based on the Holidays settings. In step 1160, the action is performed. For example, a Case may have an associated escalation policy where failure to satisfy certain criteria during normal business hours escalates the Case to the attention of another user, such as a manager. As such, Business Hours settings may cause a Case satisfying the criteria on Friday to be escalated the next Monday. The Holidays settings may be applied to determine whether the Case should be escalated the next Monday, as Monday may be a holiday. Therefore, the Case may be marked for escalation on the next Tuesday. FIG. 11 ends in step 1170.

It should be understood that embodiments of the present invention as described above can be implemented in the form of control logic using hardware and/or using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer program product (e.g. a hard drive or an entire computer system), and may be present on or within different computer program products within a system or network. A computer system may include a monitor, printer, or other suitable display system for providing any of the results mentioned herein to a user.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method performed by one or more computer systems associated with an on-demand service for handling emails, the method comprising:
forwarding, from at least one of the one or more computer systems associated with the on-demand service, information configured for displaying one or more user interfaces on a display device, the one or more user interfaces being configured to accept input from users of the one or more user interfaces specifying how the one or more computer systems associated with the on-demand service handle emails;
receiving, at least one of the one or more computer systems, a set of Email To Case settings specified via the one or more user interfaces;
storing, in a storage device associated with the one or more computer systems, the set of Email to Case settings;
receiving an email at least one of the one or more computer systems; and
generating, with one or more processors associated with the one or more computer system, information associated with a Case based on the email and the stored Email to Case settings.

2. The method of claim 1 where receiving, at least one of the one or more computer systems, a set of Email To Case settings specified via the one or more user interfaces comprises receiving at least a routing address associated with a email services address.

3. The method of claim 1 where receiving, at least one of the one or more computer systems, a set of Email To Case settings specified via the one or more user interfaces comprises receiving an indication to store email headers; and
wherein generating, with the one or more processors associated with the one or more computer system, the information associated with the Case based on the email and the stored Email to Case settings comprises storing metadata associated with the email.

4. The method of claim 1 where receiving, at least one of the one or more computer systems, a set of Email To Case settings specified via the one or more user interfaces comprises receiving information specifying a task to create upon receiving emails; and
wherein generating, with the one or more processors associated with the one or more computer system, the information associated with the Case based on the email and the stored Email to Case settings comprises creating a task for the Case.

5. The method of claim 4 where further comprising setting, with the one or more processors associated with the one or more computer systems, attributes of the task based on the Email to Case settings.

6. The method of claim 1 where receiving, at least one of the one or more computer systems, a set of Email To Case settings specified via the one or more user interfaces comprises receiving an indication whether to notify an owner of the Case of the email; and
wherein generating, with the one or more processors associated with the one or more computer system, the information associated with the Case based on the email and the stored Email to Case settings comprises generating a notification to the owner of the Case.

7. The method of claim 1 where receiving, at least one of the one or more computer systems, a set of Email To Case settings specified via the one or more user interfaces comprises receiving an indication whether to enable HTML content associated with received emails.

8. The method of claim 1 where receiving, at least one of the one or more computer systems, a set of Email To Case settings specified via the one or more user interfaces comprises receiving a priority to be assigned to the Case.

9. The method of claim 1 where receiving, at least one of the one or more computer systems, a set of Email To Case settings specified via the one or more user interfaces comprises receiving a case origin to be assigned to the Case.

10. The method of claim 1 where receiving, at least one of the one or more computer systems, a set of Email To Case settings specified via the one or more user interfaces comprises receiving a case record type to be assigned to the Case.

11. The method of claim 1 where receiving, at least one of the one or more computer systems, a set of Email To Case settings specified via the one or more user interfaces comprises receiving one or more error handling settings.

12. A computer-readable storage medium storing one or more software programs executable by one or more computer systems for handling emails in an on-demand service, the computer-readable storage medium comprising:
code for forwarding information configured for displaying one or more user interfaces on a display device, the one or more user interfaces being configured to accept input from users of the one or more user interfaces specifying how the one or more computer systems associated with the on-demand service handle emails;
code for receiving a set of Email To Case settings specified via the one or more user interfaces;
code for receiving an email; and
code for generating information associated with a Case based on the email and the stored Email to Case settings

13. A method performed by one or more computer systems associated with an on-demand service for handling user permissions, the method comprising:
forwarding, from at least one of the one or more computer systems associated with the on-demand service, information configured for displaying one or more user interfaces on a display device, the one or more user interfaces being configured to accept input from users of the one or more user interfaces specifying how the one or more computer systems associated with the on-demand service handle permissions for a portal;
receiving, at least one of the one or more computer systems, information establishing a portal super user specified via the one or more user interfaces;
storing, in a storage device associated with the one or more computer systems, the information establishing the portal super user;
receiving a request at least one of the one or more computer systems to access a Case; and
generating, with one or more processors associated with the one or more computer system, information associated with the Case based on the stored information establishing the portal super user.

14. The method of claim 13 wherein generating, with the one or more processors associated with the one or more computer system, the information associated with the Case based on the stored information establishing the portal super user comprises generating information associated with a Case owned by a user with a portal super user permission.

15. The method of claim 13 wherein generating, with the one or more processors associated with the one or more computer system, the information associated with the Case based on the stored information establishing the portal super user comprises generating information associated with a Case owned by another user by under a user with a portal super user permission.

16. A computer-readable storage medium storing one or more software programs executable by one or more computer systems for implementing the method recited in claim 13.

17. A method performed by one or more computer systems associated with an on-demand service for handling user permissions, the method comprising:
forwarding, from at least one of the one or more computer systems associated with the on-demand service, information configured for displaying one or more user interfaces on a display device, the one or more user interfaces being configured to accept input from users of the one or more user interfaces specifying how the one or more computer systems associated with the on-demand service handle permissions for Case Teams;
receiving, at least one of the one or more computer systems, a set of Case Teams settings specified via the one or more user interfaces;
storing, in a storage device associated with the one or more computer systems, the set of Case Teams settings; and
generating, with one or more processors associated with the one or more computer system, information associated with a Case based on the stored Case Teams settings.

18. The method of claim 17 wherein receiving, at least one of the one or more computer systems, the set of Case Teams settings specified via the one or more user interfaces comprises receiving information designating one or more users of the one or more computer systems as members of a Case Team.

19. The method of claim 17 wherein receiving, at least one of the one or more computer systems, the set of Case Teams settings specified via the one or more user interfaces comprises receiving information designating one or more queues as members of a Case Team.

20. The method of claim 17 wherein receiving, at least one of the one or more computer systems, the set of Case Teams settings specified via the one or more user interfaces comprises receiving information designating one or more customer portal users as members of a Case Team.

21. The method of claim 17 wherein receiving, at least one of the one or more computer systems, the set of Case Teams settings specified via the one or more user interfaces comprises receiving information designating one or more partner portal users as members of a Case Team.

22. The method of claim 17 wherein receiving, at least one of the one or more computer systems, the set of Case Teams settings specified via the one or more user interfaces comprises receiving information designating one or more contacts associated the Case as members of a Case Team.

23. The method of claim 17 wherein receiving, at least one of the one or more computer systems, the set of Case Teams settings specified via the one or more user interfaces comprises receiving notification settings for a member of a Case Team.

24. The method of claim 23 wherein generating, with the one or more processors associated with the one or more computer system, information associated with the Case based on the stored Case Teams settings comprises generating one or more types of notifications based on the notification settings.

25. The method of claim 17 wherein receiving, at least one of the one or more computer systems, the set of Case Teams settings specified via the one or more user interfaces comprises receiving sharing settings for a member of a Case Team.

26. The method of claim 25 wherein receiving, at least one of the one or more computer systems, the set of Case Teams settings specified via the one or more user interfaces comprises receiving visibility settings for a member of a Case Team.

27. The method of claim 17 wherein receiving, at least one of the one or more computer systems, the set of Case Teams settings specified via the one or more user interfaces comprises receiving one or more predefined case teams.

28. The method of claim 27 further comprising modifying, with the one or more processors associated with the one or more computer systems, at least one of the one or more predefined case teams in response to a change to a user associated with the at least one predefined case team.

29. A computer-readable storage medium storing one or more software programs executable by one or more computer systems for implementing the method of claim 17.

30. A method performed by one or more computer systems associated with an on-demand service for handling holidays, the method comprising:
forwarding, from at least one of the one or more computer systems associated with the on-demand service, information configured for displaying one or more user interfaces on a display device, the one or more user interfaces being configured to accept input from users of the one or more user interfaces specifying how the one or more computer systems associated with the on-demand service handle holidays;
receiving, at least one of the one or more computer systems, a set of holiday settings specified via the one or more user interfaces;
storing, in a storage device associated with the one or more computer systems, the set of holiday settings; and
generating, with one or more processors associated with the one or more computer system, information associated with a Case based on the stored holiday settings.

31. The method of claim 30 wherein receiving, at least one of the one or more computer systems, a set of holiday settings specified via the one or more user interfaces comprises receiving information defining a holiday on an individual day.

32. The method of claim 30 wherein receiving, at least one of the one or more computer systems, a set of holiday settings specified via the one or more user interfaces comprises receiving information defining a holiday on an repeating interval.

33. A computer-readable storage medium storing one or more software programs executable by one or more computer systems for implementing the method of claim 30.
